(19) United States
(12) Patent Application Publication
(10) Pub. No.: US 2012/0078681 A1
(43) Pub. Date: Mar. 29, 2012

(54) MULTI-HIERARCHICAL CUSTOMER AND PRODUCT PROFILING FOR ENHANCED RETAIL OFFERINGS

(75) Inventors: Shafi Ur Rahman, Bangalore (IN); Pawan Saraswat, New Tippasandra (IN); Amit Kiran Sowani, Mumbai (IN); Gerald Fahner, Austin, TX (US)

(73) Assignee: FAIR ISAAC CORPORATION, Minneapolis, MN (US)

(21) Appl. No.: 12/890,332

(22) Filed: Sep. 24, 2010

(51) Int. Cl. G06F 17/30

(52) U.S. Cl. 705/7.29

(57) ABSTRACT

The current subject matter provides the ability to infer a richer customer profile using purchase transaction data in conjunction with various hierarchical groupings of products as well as an ability to characterize products such that they can be used to enrich customer profiles. Related apparatus, systems, techniques and articles are also described.

### TECHNICAL FIELD

The subject matter described herein relates to techniques for generating multi-hierarchical customer and product profiles for devising and/or enhancing retail offerings.

### BACKGROUND

Direct marketing is shifting from traditional mailing and coupon offer campaigns to a more customer-centric marketing paradigm that considers the different actions that can be taken for a specific customer and decides the best option for each individual customer. This action can be an offer, a proposition or a service. It can be determined by the customer's interests and needs on one hand, and the marketing organization's business objectives, policies, and regulations on the other. Results of such efforts are largely dependent on how much information is known about the customers prior to offering such actions.

### SUMMARY

In a first aspect, product features are identified for a plurality of products. Thereafter, a data dictionary mapping the identified plurality of products to tokens is generated. In addition, context vectors are generated based on pre-defined product descriptions and the tokens in the dictionary. A Euclidian distance is determined between the generated context vectors so that product features having context vectors with corresponding Euclidian distance equal or less to a pre-defined threshold can be identified. Thereafter, a plurality of product clusters can be generated using the identified product features such that the clusters are distinguishable. Optionally, one or more transactions (e.g., advertisements, discounts, bundling, offerings, etc.) can be initiated based on the generated product clusters.

At least two characteristics can be generated for each of a plurality of products that include at least one of the identified product features. A first characteristic can specify how frequently the product was purchased. A second characteristic can specify how recent the product was purchased. In some implementations, the one or more transactions are further based on the generated characteristics.

The product descriptions can form part of a Stock Keeping Unit (SKU). The initiating one or more transactions can use a Time to Event scorecard model. In such cases, the generated characteristics and customer demographic material can be processed using a variable selection algorithm to optimize a likelihood of success of the transactions.

In another aspect, a matrix M is populated using historical customer basket data relating to products α and β purchased in connection with a plurality of unique customer baskets, where, each cell (α,β) of the matrix M represents co-occurrence counts of products α and β; if there are J products in a particular customer basket then there are J(J−1)/2 unique pairs of products; corresponding counts in the cells in the matrix M can be updated for each of these pairs. In addition, similarity values S are generated for each cell (α,β) in the matrix M using: S(α, β)=N(α,β)/N(α)*N(β) where, N(α, β)=number of baskets shared by products α and β; N(α)=number of baskets that were associated with α in historical customer basket data; and N(β)=number of baskets that were associated with β in historical customer basket data. Thereafter, clusters of the products having generated similarity values below a pre-defined threshold can be identified. Optionally, one or more transactions can be initiated based on the generated product clusters.

At least two characteristics can be generated for each of a plurality of products in the clusters, at least two characteristics. Similar to above, a first characteristic specifies how frequently the product was purchased and a second characteristic specifies how recent the product was purchased. The one or more transactions can be based on the generated characteristics.

The one or more transactions can use a Time to Event scorecard model in which the generated characteristics and customer demographic data are processed using a variable selection algorithm to optimize a likelihood of success of the transactions. The variable selection algorithm can be trained with combinations of the characteristics and resulting divergences are computed such that combinations of the characteristics having a divergence above a pre-defined threshold are utilized for a final model of the variable selection algorithm. Related products can be identified based on the clusters of the products and new customer profiles can be generated or historical customer profiles modified using the related products. In addition or in the alternative, the products can be hierarchically clustered.

In still a further aspect, a line item is generated for each of a plurality of customers purchase transactions based on identifiers for products purchased during the purchase transaction. Each generated line item is mapped to at least one virtual item, each virtual item comprising at least one keyword characterizing the corresponding product and having an associated virtual item type categorizing the virtual item. Thereafter, one or more transactions can be initiated using the generated line items and the mapped at least one virtual item and the associated virtual item type.

The line item can correspond to a Stock Keeping Unit (SKU). At least two characteristics can be generated for each of the plurality of virtual items. A first characteristic can specify how frequently a product with a line item mapped to such virtual item was purchased and a second characteristic can specify how recent a product with a line item mapped to such virtual item was purchased (and such characteristics can be used when initiating transactions). The initiation of the one or more transactions can use a Time to Event scorecard model. Relatedly, the generated characteristics along with customer demographic material can be processed using a variable selection algorithm to optimize a likelihood of success of the transactions. The variable selection algorithm can be trained with combinations of the characteristics so that resulting divergences can be computed. Combinations of the characteristics having a divergence above a pre-defined threshold can then be utilized for a final model of the variable selection algorithm.

Articles of manufacture are also described that comprise computer executable instructions permanently stored (e.g., non-transitorily stored, etc.) on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. Computer-implemented methods as described herein can include methods in which operations are implemented by one or more data processors (which may be unitary or distributed across two or more computing systems).

The subject matter described herein provides many advantages. By providing the ability to infer or derive greater user profiling information based on limited purchase information, more informed decisions can be generated. This in turn can result in a greater return on investment of companies adopting the current subject matter. Moreover, the current subject matter is advantageous in that is provides the ability to characterize products such that they can be used to enrich customer profiles (e.g., life-stage, lifestyle, etc.).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating the generation of product clusters using context vectors for use in initiating one or more transactions;

FIG. 2 is a is a process flow diagram illustrating generation of product clusters using a matrix defining similarity values for use in initiating one or more transactions; and

FIG. 3 is a process flow diagram illustrating generation of virtual items and virtual item types for enhancing product line items for use in inferring deeper customer behavior profiles.

### DETAILED DESCRIPTION

The current subject matter can be used in connection with retail marketing systems having a decisioning capability (e.g., real-time or near real-time decisioning capability) that combines a data mining algorithm that adjusts predictions based on the success of previous predictions and a rules engine that arbitrates among possible recommendations based on the enterprise's strategic priorities. This decisioning capability can be informed by analytics, to decide the next best offering to be made to a customer based on their profile (which can be based, in part, on their purchase history). According to Gartner, the market research firm, this market was worth $500M in 2005 and is slated to rise to $700M for 2010.

Purchase data along with customer demographic information (collectively customer profiling data) can be used to predict future propensities of customers for buying various products. Often multiple Stock Keeping Units (SKUs) can be grouped together at a more appropriate level to reduce data fragmentation. SKU information can be grouped at this hierarchical level for computing models that predict an individual customer's propensity to buy corresponding products. Time to Event (TTE) scorecard models can be created for each item at that hierarchical level (for example, see, U.S. patent application Ser. No. 12,197,134 published as U.S. Pat. App. Pub. No. 2010/0049538, the contents of which are hereby fully incorporated by reference). Purchase data can be used to compute characteristics representing how recently and how frequently each of the products are purchased. This information along with customer demographic data can be processed through, for example, a variable selection algorithm to select the most effective characteristics for each TTE scorecard model.

Purchase of a single SKU can represent a multitude of information about the customer's behavior and future needs. For example, purchase of a 52″ SONY LCD TV represents not only purchase of an LCD TV at an appropriate grouping level, but is also indicative of additional relevant profiling information such as customer potential bias for the brand, the customer's inclination to purchase electronic items, their lifestyle etc. The current subject matter enables derivation of greater profiling information from the purchase of a single or a handful of products and/or services. This profiling information can then be used to drive more informed decisions.

The current subject matter uses two approaches to obtain more relevant information for customer profiling purposes. First, the current subject matter enables inferring of new types of information for each product, called product features, using two computational approaches. Second, the current subject matter provides a software framework based on which these product features as well as additional hierarchical levels for individual SKU purchases can be utilized in models without loss of information, data fragmentation or data bias.

Customer profiles as used herein can comprise a rich set of characteristics that capture relevant details about customers that lead to purchase of various products. These characteristics can be broadly grouped into three distinct categories: a) seasonality, b) static demographic information pertaining to the customer and, c) dynamic purchase pattern of the customer. The dynamic purchase pattern can comprise a rich set of customer characteristics that capture how recently and how frequently various products were purchased. At an appropriate SKU grouping level, if there are 1000 products, then this leads to 2000 characteristics. Purchase of a targeted product can depend on the recency and frequency of other or same products. For example, purchase of milk can depend on how recently and how frequently a customer purchased milk or grocery. Similarly, purchase of an audio accessory can depend on how recently a customer purchased a digital audio player. Often the interactions are more complicated than these examples and hence a scorecard model can be used to capture the interactions accurately to compute individual purchase propensity of a targeted product.

As stated above, new types of information can be inferred for each product using data driven approach. Some of the product features can be implied by the product hierarchies that are internally managed by the retailers. But this sort of grouping does not always provide significant insight into the customers' life style, life stage, spending power etc. Two approaches can be used to determine these product features for the SKUs.

The first product feature approach can be a context vector based approach. An approach for determining context vectors can be found in U.S. Pat. No. 5,619,709 entitled: “System and method of context vector generation and retrieval”, the contents of which are hereby fully incorporated by reference. A list of product features can be identified and a dictionary can be developed containing keywords (tokens) that are mapped to named product features (e.g., SKU descriptions, etc.) based on domain knowledge. Context vectors can then evaluated for the SKU descriptions and for the tokens in the dictionary. A Euclidian distance between SKU descriptions context vectors and token context vectors can then be computed. The closest tokens represent the product feature for each SKU. In case of tie between two tokens, the SKUs can be mapped to both features. These named product features for SKUs lead to grouping of SKUs and are used in customer profiling.

Product features represent certain aspects of a product group that distinguishes that group for the rest. For instance product feature groups can be based on the lifestyle of the consumers. An example would be a “Health Conscious” product group. Such a group can be identified by occurrence of key words ‘health’, ‘organic’, ‘exercise’, ‘energy drinks’, ‘isotonic beverages’, ‘vitamins’, ‘kashi’ etc in the SKU description of the products. Another example is “Green” which can be associated with keywords ‘organic’, ‘eco friendly’, ‘recycled’, and the like. Similarly product features could represent life stage of the consumers. The keywords ‘kid’, ‘child’, ‘toy’, ‘juvenile’, ‘youth’, ‘disney’, ‘back to school’ etc represent ‘kid’ product group.

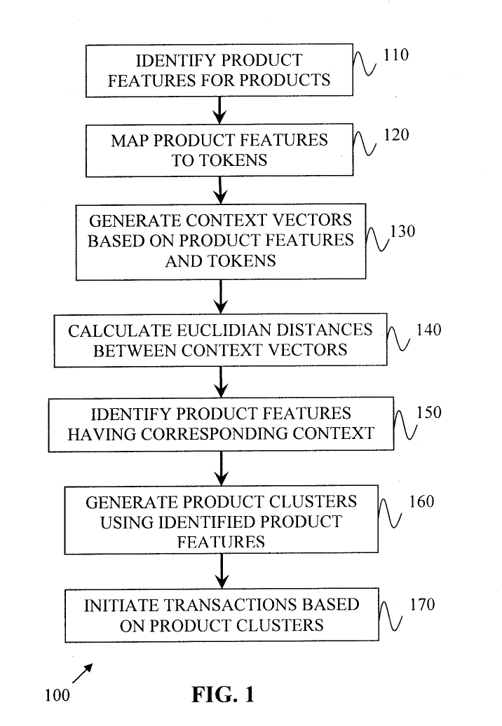

FIG. 1 is a process flow diagram illustrating a method, in which, at 110, product features are identified for a plurality of products. Thereafter, at 120, a data dictionary is generated that maps the identified plurality of products to tokens. At least one context vector is generated, at 130, based on pre-defined product descriptions and for the tokens. Euclidian distances between context vectors are, at 140, computed so that, at 150, product features having a corresponding context vector with a Euclidian distance equal or less to a pre-defined threshold are identified. Subsequently, at 160, a plurality of product clusters are generated using the identified product features such that the clusters are distinguishable. These products can be assigned together in a single data driven product group. Subsequently, at 170, one or more transactions can based on the generated product clusters are initiated.

The second product feature approach can use a data driven algorithm to compute product groups. Each unique customer visit to the retailer's store can represent a unique customer basket. Product pairs can be formed for the products bought in a single customer basket and a similarity matrix can be populated. This process can be carried out for each product pair across all the customer baskets in the retailer's transaction database.

Let M represent a two dimensional diagonal matrix, with each matrix cell (α,β) representing the co-occurrence count of products α and β. If there are J products in customer basket, then there are J(J−1)/2 unique pairs of products. The corresponding counts in the cells in the matrix M can be updated for each of these pairs. Similarity values can then be computed for each cell, for example, as follows:

$$S ( α , β ) = \frac{N ( α , β )}{N ( α ) * N ( β )}$$

where,

Similarity matrix;

N(α,β)=number of baskets shared by products α and β;

N(α)=number of baskets that were associated with α in historical data; and

N(β)=number of baskets that were associated with β in historical data.

The products can then be hierarchically clustered based on similarity metrics for each product pair. Hierarchical clustering is an efficient and fast approach for grouping entities into related clusters or groups based on the degree of similarity or dissimilarity. This can be based on a distance metric, such that entities within each cluster are more closely related to one another than objects assigned to different clusters. These hierarchical clusters can then be used to find sets of related products. These product groups represent data driven product features, and can be used in customer profiling. As will be described in further detail below, product feature information as well as additional information pertaining to various hierarchical groupings of Stock Keeping Units (SKUs) can be used to compute a richer customer profile from purchase transaction data.

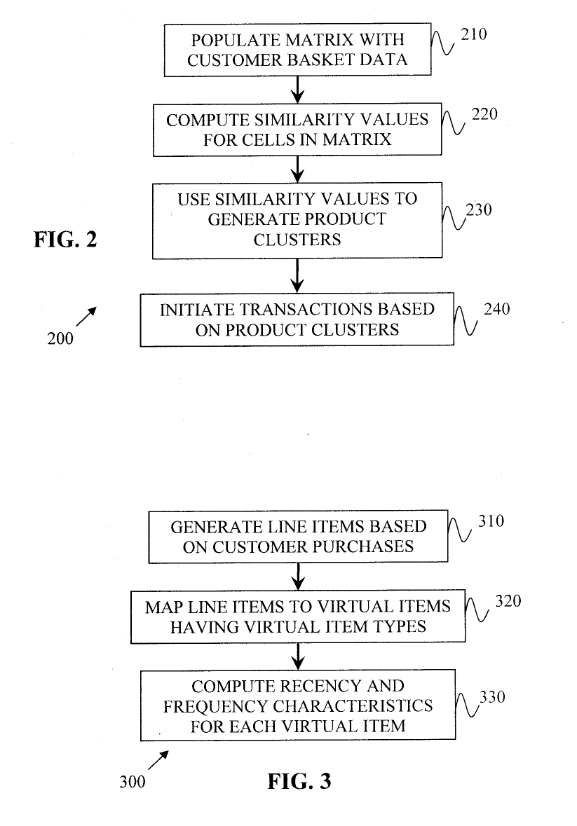

FIG. 2 is a process flow diagram that illustrates a method 200, in which, at 210, a matrix M is populated using historical customer basket data relating to products α and β purchased in connection with a plurality of unique customer baskets. Each cell (α,β) of the matrix M represents co-occurrence counts of products α and β. If there are J products in a particular customer basket then there are J(J−1)/2 unique pairs of products. With regard to matrix M, corresponding counts in the cells can be updated for each of these pairs. Thereafter, at 220, similarity values S can be computed for each cell (α,β) in the matrix M using:

$$S ( α , β ) = \frac{N ( α , β )}{N ( α ) * N ( β )}$$

where, N(α,β)=number of baskets shared by products α and β; N(α)=number of baskets that were associated with α in historical customer basket data; and N(β)=number of baskets that were associated with β in historical customer basket data. Clusters of the products are, at 230, identified using hierarchical clustering based on the degree of similarity above a pre-defined threshold. Once the clusters have been generated, at 240, one or more products have been assigned together in a single data driven product group.

As stated above, a framework can be provided for utilizing additional information corresponding to the individual SKU purchases in models without loss of information, data fragmentation or data bias. Transaction data in the retail domain can contain one entry for each SKU purchased by a customer on a given date, which is called a line item. Typically, for creating models, as described earlier, an appropriate hierarchical level can be chosen from retailers SKU hierarchy and a SKU can be mapped to this level. Customer profiles are then generated using this mapped data. The appropriate hierarchical level is determined by the granularity of grouping of SKUs required which is dictated by the business objectives. For most applications this is at the subcategory level, which is grouping of related SKUs abstracting details like features, brand and packaging size but otherwise similar in all other respects, e.g., LCD TV is one subcategory which encompassed all LCD TVs of various sizes, features and brands.

In order to incorporate additional information corresponding to each SKU, a virtualization framework can be provided. In this context, virtualization works by introducing additional line items corresponding to each “real” line item in the data. The SKUs in these additional line items can be mapped to various product features and various levels of SKU hierarchy, called virtual item types. The following table illustrates such mapping.

| Line Item Data (as SKU | | |
|---|---|---|
| level) | Virtual Item | Virtual Item Type |
| 52″ Sony Bravia LCD | LCD TV | Subcategory (product hierarchy) |
| Model: KDL-52V5100 | Electronic | Category (product hierarchy) |
| | Sony | Brand |
| | Luxury | Lifestyle (product feature) |
| Huggies Snug & Dry | Diapers | Subcategory (product hierarchy) |
| Diapers Step 3 - 204 ct | Baby Care | Category (product hierarchy) |
| | Huggies | Brand |
| | Infant | Lifestage (product feature) |

These product features, brands and various levels of SKU hierarchy can act as “virtual” products. Each “virtual” line item can then represent a particular type of grouping that the SKU belongs to. These “virtual” line items can then be used to compute characteristics representing how recently and how frequently each of the “virtual” products are purchased. In the above example, recency and frequency of virtual products “LCD TV”, “Electronic”, “Sony” and “Luxury” are computed. As opposed to this approach, in conventional approaches, each line item was mapped only to one (appropriate) level of SKU hierarchy and characteristics were computed for this level of product grouping.

These virtual line items can be mutually independent of each other, meaning that existence of one type of “virtual” product, say product life style, does not impact the computation of characteristics based on another type of “real” or “virtual” product, say life stage. This mutual independence ensures that impact of purchase of a virtual product is neither over counted nor under counted. These “virtual” products can act as both a source of characteristics as well as the target for which models are created. A variable selection algorithm can be then used to select the most effective characteristics for each product for to be modeled. For a scorecard model, variable selection requires an exhaustive search of all possible subsets of features of the chosen cardinality. This can be accomplished by computing an information value of each variable and selecting top values (e.g., top 100, etc.). Subsequently, models can be trained with various combinations of these 100 selected variables, and their divergence can be computed. The model with the highest divergence can be selected as the final model. Typically, a selected model has much less than 100 variables. Model in this regard is a mathematical representation of the relationship between one or more variables and the intended outcome, e.g., purchase of the product.

The virtualization framework is advantageous in that it is highly scalable which allows for inferring arbitrarily large number of types of information regarding SKUs.

Creation of the product features representing lifestyle and life-stage can be used to enrich customer profiles, by computing characteristics representing how recently and how frequently products belonging to each of the lifestyle and life-stage categories are purchased. As illustrated in the previous examples, for each customer, recency and frequency of purchase of lifestyle and life-stage, e.g., “luxury” and “kid” respectively, corresponding to the purchased item can be computed. By virtue of capturing additional information about a customer's purchase pattern the customer profiles are enriched. These product features can be treated as “virtual” products associated with SKUs which can be used not only as model characteristics but also for creating models for capturing propensity of customers to purchase products belonging to particular lifestyle or life-stage categories.

In some cases, retailers desire to give thematic offers to customers where each offer has an underlying story, project or a theme, e.g.: electronic goods. Models can be created for various themes, with a combination of “virtual” theme products to identify their characteristics. The models can represent a customer's propensity to start a particular project, or to buy products of a particular theme as opposed to those of other themes. The multi-hierarchical modeling technique allows for the capture of customer behavior more accurately by creating purchase variables at multiple levels of granularity.

The current subject enables the creation of models for various brands of products, e.g., SONY, SAMSUNG, etc., where the most effective combination of “real” and “virtual” products can be used to compute the characteristics. These models represent customers' propensities to purchase products of one brand as opposed to a different brand. This has become possible due to the ability of the current subject matter to coax multiple levels of information from a single SKU purchase. This enriched set of brand models can not only increases revenue for retailers, but helps companies that drive targeted campaigns. As lot of the retail analytic effort is driven by consumer brands, these brand models can help drive a large return on investment to these companies.

Similarly, models can be created for SKUs along with higher hierarchical level of products, which was not possible earlier, due to the large volume of SKUs for any typical client. A judicious combination can allow highly precise selection of customers who are most likely to purchase a particular SKU versus another SKU of the same product group. With this capability differentiation among different specific SKU properties like size, color, etc. within the category can be realized.

FIG. 3 is a process flow diagram illustrating a method 300 in which, at 310, a line item is generated for each of a plurality of customers purchase transactions that is based on identifiers for products purchased during the purchase transaction. Thereafter, at 320, each generated line item is mapped to at least one virtual item. In this context, each virtual item comprises at least one keyword characterizing the corresponding product and each virtual item has an associated virtual item type categorizing the virtual item. These mappings can be used to initiate one or more transactions using the generated line items and the mapped at least one virtual item and the associated virtual item type. At 330, recency and frequency characteristics for each virtual item is computed to be used in the models.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, the skilled artisan will appreciate that references to products include services and other actions (unless otherwise explicitly stated). Other embodiments may be within the scope of the following claims.

What is claimed is:

1. A method for implementation by one or more data processors comprising:
identifying product features for a plurality of products;
generating a data dictionary mapping the identified plurality of products to tokens;
generating context vectors based on pre-defined product descriptions and the tokens in the dictionary;
determining Euclidian distances between the generated context vectors;
identifying product features having context vectors with corresponding Euclidian distance equal or less to a pre-defined threshold; and
generating a plurality of product clusters using the identified product features such that the clusters are distinguishable.

2. A method as in claim 1, further comprising:
initiating one or more transactions based on the generated product clusters.

3. A method as in claim 2, further comprising:
generating, for each of a plurality of products that include at least one of the identified product features, at least two characteristics, a first characteristic specifying how frequently the product was purchased, a second characteristic specifying how recent the product was purchased;
wherein the one or more transactions are further based on the generated characteristics.

4. A method as in claim 1, wherein the product descriptions form part of a Stock Keeping Unit (SKU).

5. A method as in claim 1, wherein the initiating one or more transactions uses a Time to Event scorecard model.

6. A method as in claim 5, wherein the initiating one or more transaction further comprises:
processing the generated characteristics and customer demographic material using a variable selection algorithm to optimize a likelihood of success of the transactions.

7. A method for implementation by one or more data processors comprising:
populating a matrix M using historical customer basket data relating to products α and β purchased in connection with a plurality of unique customer baskets;
wherein each cell (α,β) of the matrix M represents co-occurrence counts of products α and β;
wherein if there are J products in a particular customer basket then there are J(J−1)/2 unique pairs of products;
wherein corresponding counts in the cells in the matrix M can be updated for each of these pairs;
generating similarity values S for each cell (α,β) in the matrix M using:
$$S ( α , β ) = \frac{N ( α , β )}{N ( α ) * N ( β )}$$
where,
N(α,β)=number of baskets shared by products α and β;
N(α)=number of baskets that were associated with α in historical customer basket data; and
N(β)=number of baskets that were associated with β in historical customer basket data; and
identifying clusters of the products having generated similarity values below a pre-defined threshold.

8. A method as in claim 7, further comprising:
initiating one or more transactions based on the generated product clusters.

9. A method as in claim 8, further comprising:
generating, for each of a plurality of products in the clusters, at least two characteristics, a first characteristic specifying how frequently the product was purchased, a second characteristic specifying how recent the product was purchased;
wherein the one or more transactions are further based on the generated characteristics.

10. A method as in claim 7, wherein the initiating one or more transactions uses a Time to Event scorecard model.

11. A method as in claim 10, wherein the initiating one or more transaction further comprises:
processing the generated characteristics and customer demographic data using a variable selection algorithm to optimize a likelihood of success of the transactions.

12. A method as in claim 11, wherein the variable selection algorithm is trained with combinations of the characteristics and resulting divergences are computed;
wherein combinations of the characteristics having a divergence above a pre-defined threshold are utilized for a final model of the variable selection algorithm.

13. A method as in claim 7, further comprising:
identifying related products based on the clusters of the products; and
generating new customer profiles or modifying historical customer profiles using the related products.

14. A method as in claim 13, wherein the products are hierarchically clustered.

15. A method comprising:
generating a line item, for each of a plurality of customers purchase transactions, based on identifiers for products purchased during the purchase transaction;
mapping each generated line item to at least one virtual item, each virtual item comprising at least one keyword characterizing the corresponding product and having an associated virtual item type categorizing the virtual item; and
initiating one or more transactions using the generated line items and the mapped at least one virtual item and the associated virtual item type.

16. A method as in claim 15, wherein the line item corresponds to a Stock Keeping Unit (SKU).

17. A method as in claim 15, further comprising:
generating, for each of the plurality of virtual items, a first characteristic specifying how frequently a product with a line item mapped to such virtual item was purchased, a second characteristic specifying how recent a product with a line item mapped to such virtual item was purchased; and
wherein the one or more transactions are further based on the generated characteristics.

18. A method as in claim 17, wherein the initiating one or more transactions uses a Time to Event scorecard model.

19. A method as in claim 18, wherein the initiating one or more transaction further comprises:
processing the generated characteristics and customer demographic material using a variable selection algorithm to optimize a likelihood of success of the transactions.

20. A method as in claim 19, wherein the variable selection algorithm is trained with combinations of the characteristics and resulting divergences are computed;
wherein combinations of the characteristics having a divergence above a pre-defined threshold are utilized for a final model of the variable selection algorithm.
